(19) United States
(12) Patent Application Publication
(10) Pub. No.: US 2026/0117089 A1
(43) Pub. Date: Apr. 30, 2026

(54) SILICONE POLYETHER WITH LINEAR PENDANT POLYETHER GROUP

(71) Applicant: Dow Silicones Corporation, Midland, MI (US)

(72) Inventors: Maxime Szymutko, Seneffe (BE); Pierre Chevalier, Seneffe (BE); Cathy Dontaine, Mons (BE)

(21) Appl. No.: 19/473,511

(22) PCT Filed: May 3, 2024
(86) PCT No.: PCT/US2024/027584

§ 371 Date: Oct. 8, 2025

Related U.S. Application Data
(60) Provisional application No. 63/468,089, filed on May 22, 2023.

(51) Int. Cl. C09D 183/06; C09D 5/02

(52) U.S. Cl. CPC C09D 183/06; C09D 5/022

(57) ABSTRACT

A composition includes a silicone polyether having the following chemical structure: (CH₃)₃SiO—Y(CH₃)SiO—Si(CH₃)₃ wherein Y is —(CH₂)₂O(CH₂)₄O(CH₂CH₂O)ₙH and subscript n has an average value in a range of one to 500.

### FIELD

The present invention relates to a polyether polyol having a linear pendant polyether extending from a siloxane backbone.

### INTRODUCTION

Release coatings for bakery paper benefit from water resistance and, or course, high release character for baked goods. Use of silicone emulsions for coating bakery paper to achieve these desirable properties is an attractive alternative to release coatings comprising chrome complexes and fluoro-polymers because of health concerns associated with those latter materials. However, a challenge with silicone emulsion coatings is achieving food release performance of bakery residue values below 12 grams per square meter (g/m²) in the Bakery Release test. This is particularly challenging to achieve while simultaneously achieving water resistance performance sufficient to achieve a Water Uptake value of less than 20 g/m², preferably less than 15 g/m² in the Cobb Water Resistance test.

### SUMMARY

The present invention provides a solution to the need for a silicone emulsion that can provide a release coating that achieves less than 12 g/m² bakery residue in the Bakery Release test and a Water Uptake value of less than 20 g/m², and even less than 15 g/m² in the Cobb Water Resistance test.

The present invention is a result of discovering a silicone polyether (SPE) that surprisingly imparts the bakery residue and water resistance performance to a silicone emulsion while other SPE materials do not. The SPE has a specific 3-silicon siloxane backbone which appears to impart emulsion stability in contrast to longer siloxane backbone SPEs. It also has one linear polyether pendant group. The specific linkage between the siloxane backbone and polyether units has been found to be important for achieving the target baking residue values.

In a first aspect, the present invention is a composition comprising a silicone polyether having the following chemical structure: (CH₃)₃SiO—Y(CH₃)SiO—Si(CH₃)₃ wherein Y is —(CH₂)₂O(CH₂)₄O(CH₂CH₂O)ₙH and subscript n has an average value in a range of one to 500.

The composition can comprise, or consist of, just the silicone polyether. Alternatively, the composition can comprise additional components. The composition can comprise components to form a curable release coating composition emulsion that contains an aliphatically unsaturated polyorganosiloxane, a polyorganohydrogensiloxane, a hydrosilylation reaction catalyst, a hydrosilylation reaction inhibitor, water, a buffer, the silicone polyether, optionally a polyvinyl alcohol, optionally a biocide, optionally a co-surfactant, and optionally an anti-foaming agent. The composition can further comprise a substrate such as paper sheet with the coating composition coating at least one surface of the substrate.

The present invention is useful for use in baking paper to provide a substrate that is water resistant and achieves low bakery residues.

### DETAILED DESCRIPTION

Products identified by their tradename refer to the compositions available under those tradenames on the priority date of this document.

“Multiple” means two or more. “And/or” means “and, or as an alternative”. All ranges include endpoints unless otherwise indicated.

“Alkyl” refers to a hydrocarbon radical derivable from an alkane by removal of a hydrogen atom. An alkyl can be linear or branched.

Determine viscosity for materials using a Brookfield Viscometer DV-I Prime equipped with spindle 2 to 4, at a speed of 20 to 100 revolutions per minute and at a temperature of 25 degrees Celsius (° C.) unless otherwise stated.

The present invention is a composition comprising a silicone polyether having the following chemical structure (I):

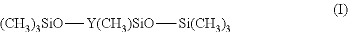

wherein Y is —(CH₂)₂O(CH₂)₄O(CH₂CH₂O)ₙH and subscript n has an average value in a range of one to 500. Subscript n can be one or more, preferably 10 or more and can be 20 or more even 30 or more, 40 or more, 50 or more, 60 or more, even 65 or more while at the same time is typically 500 or less, 300 or less, 150 or less, or even 135 or less.

The composition can consist of the silicone polyether. Alternatively, the composition comprises other components in addition to the silicone polyether. For instance, the composition can be an aqueous emulsion comprising the silicone polyether. One desirable such aqueous emulsion is a coating composition emulsion that comprises: (a) an aliphatically unsaturated polyorganosiloxane; (b) a polyorganohydrogensiloxane; (c) a hydrosilylation reaction catalyst; (d) a hydrosilylation reaction inhibitor; (e) water; (f) a buffer; (g) the silicone polyether having the chemical structure (I); (h) optionally, polyvinyl alcohol; (i) optionally, a biocide, and optionally j) a co-surfactant.

### (a) Aliphatically Unsaturated Polyorganosiloxane

The aliphatically unsaturated polyorganosiloxane of component (a) has a unit formula (A-I):

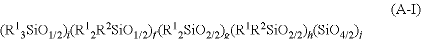

wherein each R¹ is an independently selected alkyl group, each R² is an independently selected alkenyl group, subscripts i, f, g, h, and j represent average numbers of each siloxane unit per molecule, and subscripts i, f, g, h, and j have values such that i is in a range of zero to 4, f is in a range of zero to 4; g is in a range of zero to 1400; h is in a range of zero to 200; and j is zero or one; with the provisos that if a quantity (i+f) is in a range of 2 to 4 then a quantity (f+h) is at least 2, and a quantity (i+f+g+h) is in a range of 15 to 1400.

Suitable alkyl groups for R¹ can have from 1 to 8 carbon atoms, and can be selected from a group consisting of methyl, ethyl, propyl (including isopropyl and n-propyl), butyl (including n-butyl, t-butyl, sec-butyl, and isobutyl), pentyl (including linear, branched and cyclic saturated hydrocarbon groups with 5 carbon atoms), hexyl (including linear, branched and cyclic saturated hydrocarbon groups with 6 carbon atoms), heptyl (including linear, branched and cyclic saturated hydrocarbon groups with 7 carbon atoms), and octyl (including linear, branched and cyclic saturated hydrocarbon groups with 8 carbon atoms). Suitable aryl groups include for R¹ can have from 6 to 20 carbon atoms, and can be selected from a group consisting of phenyl, tolyl, xylyl, naphthyl, and styryl. The aryl group may be phenyl. Each R¹ may be methyl or ethyl. Each R¹ may be methyl or phenyl. Each R¹ may be methyl.

Desirably, R² is selected from a group consisting of vinyl, allyl and hexenyl. R² can be selected from the group consisting of vinyl and allyl. Alternatively, R² may be selected from the group consisting of vinyl and hexenyl. Alternatively, each R² may be vinyl.

Desirably, when subscript j=0, the aliphatically unsaturated polyorganosiloxane is linear. The linear aliphatically unsaturated polyorganosiloxane can comprise unit formula (A-II): (R¹₃SiO_{1/2})ᵢ(R¹₂R²SiO_{1/2})_{f}(R¹₂SiO_{2/2})_{g}(R¹R²SiO_{2/2})ₕ, where R¹ is an independently selected alkyl group or aryl group as described above, R² is an independently selected alkenyl group as described above, subscript i is 0, 1, or 2; subscript f is 0, 1, or 2; subscript g is 0 to 1200; and subscript h is 0 to 200; with the provisos that the quantity (i+f)=2, the quantity (f+h)≥2, and the quantity (i+f+g+h) is 15 to 1200.

The linear aliphatically unsaturated polyorganosiloxane can comprise a bis-alkenyl-endblocked polydialkylsiloxane (when i=0, f=2, and h=0). The bis-alkenyl-endblocked polydialkylsiloxane may have unit formula (A-III): (R¹₂R²SiO_{1/2})₂(R¹₂SiO_{2/2})_{g}, where each R¹ is an alkyl group, each R² is an alkenyl group, and subscript g is 15 to 1200.

The linear aliphatically unsaturated polyorganosiloxane may comprise a poly(dialkyl/alkylvinyl)siloxane (when g>0 and h>0). The poly(dialkyl/alkylvinyl)siloxane may have unit formula (A-IV): (R²R¹₂SiO_{1/2})₂(R¹₂SiO_{2/2})_{g}(R¹R²SiO_{2/2})ₕ, where each R¹ is an alkyl group, each R² is an alkenyl group, subscript g is >0 to 1200, and subscript h is 2 to 200.

The aliphatically unsaturated polyorganosiloxane can comprise one or any combination of more than one linear aliphatically unsaturated polyorganosiloxane such as those selected from a group consisting of: (i) α,ω-dimethylvinylsiloxy-terminated polydimethylsiloxane; (ii) α,ω-dimethylvinylsiloxy-terminated poly(dimethylsiloxane/methylvinylsiloxane); (iii) α,ω-dimethylvinylsiloxy-terminated polymethylvinylsiloxane; (iv) α,ω-trimethylsiloxy-terminated poly(dimethylsiloxane/methylvinylsiloxane); (v) α,ω-trimethylsiloxy-terminated polymethylvinylsiloxane; (vi) α,ω-dimethylvinylsiloxy-terminated poly(dimethylsiloxane/methylphenylsiloxane/methylvinylsiloxane); (vii) α,ω-dimethylvinylsiloxy-terminated poly(dimethylsiloxane/methylphenylsiloxane); (viii) α,ω-dimethylvinylsiloxy-terminated poly(dimethylsiloxane/diphenylsiloxane); and (ix) α,ω-phenyl,methyl,vinyl-siloxy-terminated polydimethylsiloxane.

In addition to (or instead of) the above described linear aliphatically unsaturated polyorganosiloxane, the aliphatically unsaturated polyorganosiloxane can comprise a branched aliphatically unsaturated polyorganosiloxane. The branched aliphatically unsaturated polyorganosiloxane desirably has greater than zero mole-percent (mol %) and at the same time 5 mol % or less of quadrifunctional units based on total siloxane units in the branched aliphatically unsaturated polyorganosiloxane. For example, the branched aliphatically unsaturated polyorganosiloxane may have unit formula (A-V): (R¹₃SiO_{1/2})ᵢ(R¹₂R²SiO_{1/2})_{f}(R¹₂SiO_{2/2})_{g}(SiO_{4/2})ⱼ, where R¹ and R² are as described above, and subscripts i, f, g, and j have average values such that 2≥i≥0, 4≥f≥0, 995≥g≥4, j=1, (i+f)=4, and (i+f+g+j)>50. Alternatively, the quantity (i+f+g+j) may have a value sufficient to impart a viscosity of greater than 170 millipascal*seconds (mPa*s). Alternatively, dynamic viscosity can be greater than 170 mPa*s to 1000 mPa*s, alternatively greater than 170 to 500 mPa*s, alternatively 180 mPa*s to 450 mPa*s, and alternatively 190 mPa*s to 420 mPa*s.

Methods of preparing linear aliphatically unsaturated polyorganosiloxanes include methods such as hydrolysis and condensation of the corresponding organohalosilanes and oligomers or equilibration of cyclic polydiorganosiloxanes and are known in the art, see for example U.S. Pat. Nos. 3,284,406; 4,772,515; 5,169,920; 5,317,072; and 6,956,087. Suitable branched aliphatically unsaturated polyorganosiloxanes for the aliphatically unsaturated polyorganosiloxane can be made by known methods, such as those disclosed in U.S. Pat. No. 6,806,339 and U.S. Patent Publication 2007/0289495.

### (b) Polyorganohydrogensiloxane

The polyorganohydrogensiloxane may have unit formula (B-I): (R¹₃SiO_{1/2})_{w}(R¹₂HSiO_{1/2})ₓ(R¹₂SiO_{2/2})_{y}(R¹HSiO_{2/2})_{z}, where R¹ is as described above, subscripts w, x, y, and z represent average number of each siloxane unit per molecule and have values such that subscript w is 0, 1, or 2; subscript x is 0, 1, or 2; subscript y is 0 to 250; and subscript z is 1 to 250; with the provisos that a quantity (w+x)=2; a quantity (x+z)≥2; and a quantity (w+x+y+z) is 10 to 300. Alternatively, subscript w may be 2, and subscript x may be 0. Alternatively, subscript y may be >0 to 250. Alternatively, when the aliphatically unsaturated polyorganosiloxane (a) has two silicon bonded alkenyl groups per molecule, such as when (a) is i) α,ω-dimethylvinylsiloxy-terminated polydimethylsiloxane, then the quantity (x+z) is desirably greater than or equal to 3. Alternatively, when x=y=0 and w=2, then the polyorganohydrogensiloxane can have unit formula (B-II): (R¹₃SiO_{1/2})₂(R¹HSiO_{2/2})_{z}, where R¹ is as described above, and z is 3 to 250.

Suitable polyorganohydrogensiloxanes include any one or any combination of more than one selected from a group consisting of: (i) α,ω-dimethylhydrogensiloxy-terminated poly(dimethylsiloxane/methylhydrogensiloxane); (ii) α,ω-dimethylhydrogensiloxy-terminated polymethylhydrogensiloxane; (iii) α,ω-trimethylsiloxy-terminated poly(dimethylsiloxane/methylhydrogensiloxane); (iv) α,ω-trimethylsiloxy-terminated polymethylhydrogensiloxane; (v) α-dimethylhydrogensiloxy-ω-trimethylsiloxy-terminated poly(dimethylsiloxane/methylhydrogensiloxane); (vi) α-dimethylhydrogensiloxy-ω-trimethylsiloxy-terminated polymethylhydrogensiloxane; and (vii) α,ω-dimethylhydrogensiloxy-terminated polydimethylsiloxane.

Suitable polyorganohydrogensiloxanes are commercially available, such as those available from Gelest, Inc. of Morrisville, Pennsylvania, USA, for example, HMS-H271, HMS-071, HMS-993, HMS-301, HMS-301 R, HMS-031, HMS-991, HMS-992, HMS-993, HMS-082, HMS-151, HMS-013, HMS-053, and HMS-HM271. Methods of preparing linear and branched polyorganohydrogensiloxanes suitable for use herein, such as hydrolysis and condensation of organohalosilanes, are well known in the art, as exemplified in U.S. Pat. Nos. 2,823,218, 3,957,713, and 4,329,273.

The polyorganohydrogensiloxane (b) is desirably present in the coating composition emulsion at a concentration sufficient to provide a molar ratio of silicon bonded hydrogen atoms in the polyorganohydrogensiloxane (b) to alkenyl group in aliphatically unsaturated polyorganosiloxane (a) (that is, an SiH:Vi ratio) in a range of 1.2:1 to 3.0:1, or alternatively in a range of 1.4:1 to 2.5:1.

### (c) Hydrosilylation Reaction Catalyst

The hydrosilylation reaction catalyst is useful for promoting a hydrosilylation reaction between the alkenyl groups of the aliphatically unsaturated polyorganosiloxane (a) and the silyl hydride (SiH) groups in the polyorganohydrogen siloxane (b). The hydrosilylation catalyst can comprise a metal selected from a group consisting of iron (Fe), nickel (Ni), cobalt (Co), zirconium (Zr), titanium (Ti), and platinum-metal group metals. Desirably, the catalyst is a platinum-group metal catalyst that is selected from a group consisting of platinum, rhodium, ruthenium, palladium, osmium, and iridium. Desirably, the hydrosilylation reaction catalyst is a platinum-based catalyst.

The hydrosilylation catalyst can be triggerable, meaning they become capable of catalyzing a hydrosilylation reaction upon exposure to a triggering means. For example, the catalyst can be triggered by exposure to visible or ultraviolet light (radiation activated catalysts), or by heating (thermally activated catalysts). Radiation activated catalysts include any one or any combination of more than one selected from a group consisting of: cyclopentadienyl platinum complexes such as η5-cyclopentadienyl)tri(α-alkyl)platinum (IV); cyclopentadienyltrimethylplatinum and trimethyl(methylcyclopentadienyl)platinum(IV), cyclooctadienyl platinum complexes such as η4-1,5-cyclooctadienediarylplatinum complexes; and Pt(II)-β diketonate complexes such as bis(acetylacetonato)platinum (II). Examples of cyclopentadienyl platinum complexes are known in the art and are disclosed, for example in U.S. Pat. No. 4,510,094. Cyclooctadienyl platinum complexes are disclosed, for example, in U.S. Pat. No. 6,046,250.

Other suitable platinum-based catalysts include any one or any combination of more than one selected from a group consisting of chlorotris(triphenylphosphine)rhodium(I) (Wilkinson's Catalyst), a rhodium diphosphine chelate such as [1,2-bis(diphenylphosphino)ethane]dichlorodirhodium or [1,2-bis(diethylphosphino)ethane]dichlorodirhodium, chloroplatinic acid (Speier's Catalyst), chloroplatinic acid hexahydrate, platinum dichloride, and a complex of a compound with an alkenyl functional organopolysiloxane oligomer such as an alkenyl functional polydialkylsiloxane, a platinum group metal compound microencapsulated in a matrix or core-shell type structure. Complexes of platinum with alkenyl functional organopolysiloxane oligomers include 1,3-diethenyl-1,1,3,3-tetramethyldisiloxane complexes with platinum (Karstedt's Catalyst) and Pt(0) complex in tetramethyltetravinylcyclotetrasiloxane (Ashby's Catalyst). The hydrosilylation reaction catalyst can be a compound or complex, as described above, microencapsulated in a resin matrix. Suitable hydrosilylation reaction catalysts for are commercially available, for example, under the names SYL-OFF™ 4000 Catalyst and SYL-OFF™ 2700 that are available from The Dow Chemical Company of Midland, Michigan, USA (SYL-OFF is a trademark of Dow silicones Corporation).

The hydrosilylation catalyst (c) can be any one or any combination or more than one hydrosilylation catalyst. The amount of hydrosilylation catalyst in the coating composition emulsion should be sufficient to catalyze a hydrosilylation reaction between SiH and alkenyl groups. Desirably, the concentration of hydrosilylation catalyst (c) is 10 weight part per million (ppm) or more, 15 ppm or more, 20 ppm or more, 50 ppm or more, even 100 ppm or more, while at the same time is typically 1,000 ppm or less, 800 ppm or less, 500 ppm or less, or even 100 ppm or less where ppm of hydrosilylation catalyst is mass of the metal component in the catalyst to combined mass of aliphatically unsaturated polyorganosiloxane (a) and polyorganohydrogensiloxane (b).

### (d) Hydrosilylation Reaction Inhibitor

Hydrosilylation reaction inhibitor is useful for alternating the hydrosilylation reaction rate of the coating composition emulsion. Examples of suitable hydrosilylation reaction inhibitors include any one or any combination of more than one component selected from a group consisting of an acetylenic alcohol, a silylated acetylenic alcohol, an ene-yne compound, a triazole, a phosphine, a mercaptan, a hydrazine, an amine, a fumarate, a maleate, an ether, carbon monoxide, and an alkenyl-functional siloxane oligomer.

Examples of suitable acetylenic alcohols include 3,5-dimethyl-1-hexyn-3-ol, 1-butyn-3-ol, 1-propyn-3-ol, 2-methyl-3-butyn-2-ol, 3-methyl-1-butyn-3-ol, 3-methyl-1-pentyn-3-ol, 3-phenyl-1-butyn-3-ol, 4-ethyl-1-octyn-3-ol, 3,5-dimethyl-1-hexyn-3-ol, 1-ethynyl-1-cyclohexanol, and combinations thereof.

Examples of suitable silylated acetylenic compound include (3-methyl-1-butyn-3-oxy)trimethylsilane, ((1,1-dimethyl-2-propynyl)oxy)trimethylsilane, bis(3-methyl-1-butyn-3-oxy)dimethylsilane, bis(3-methyl-1-butyn-3-oxy)silanemethylvinylsilane, bis((1,1-dimethyl-2-propynyl)oxy)dimethylsilane, methyl(tris(1,1-dimethyl-2-propynyloxy))silane, methyl(tris(3-methyl-1-butyn-3-oxy))silane, (3-methyl-1-butyn-3-oxy)dimethylphenylsilane, (3-methyl-1-butyn-3-oxy)dimethylhexenylsilane, (3-methyl-1-butyn-3-oxy)triethylsilane, bis(3-methyl-1-butyn-3-oxy)methyltrifluoropropylsilane, (3,5-dimethyl-1-hexyn-3-oxy)trimethylsilane, (3-phenyl-1-butyn-3-oxy)diphenylmethylsilane, (3-phenyl-1-butyn-3-oxy)dimethylphenylsilane, (3-phenyl-1-butyn-3-oxy)dimethylvinylsilane, (3-phenyl-1-butyn-3-oxy)dimethylhexenylsilane, (cyclohexyl-1-ethyn-1-oxy)dimethylhexenylsilane, (cyclohexyl-1-ethyn-1-oxy)dimethylvinylsilane, (cyclohexyl-1-ethyn-1-oxy)diphenylmethylsilane, (cyclohexyl-1-ethyn-1-oxy)trimethylsilane, and combinations thereof.

Suitable ene-yne compounds include 3-methyl-3-penten-1-yne; 3,5-dimethyl-3-hexen-1-yne; and a combination thereof. A suitable triazole includes benzotriazole. A suitable amines include tetramethyl ethylenediamine, 3-dimethylamino-1-propyne, n-methylpropargylamine, propargylamine, 1-ethynylcyclohexylamine, or a combination thereof. Suitable fumarates include dialkyl fumarates such as diethyl fumarate, dialkenyl fumarates such as diallyl fumarate, dialkoxyalkyl fumarates such as bis-(methoxymethyl)ethyl fumarate. Suitable maleates include dialkyl maleates such as diethyl maleate, dialkenyl maleates such as diallyl maleate, and dialkoxyalkyl maleates such as bis-(methoxymethyl)ethyl maleate. Suitable siloxane oligomers include cyclic and linear siloxane oligomers such as methylvinylcyclosiloxanes exemplified by 1,3,5,7-tetramethyl-1,3,5,7-tetravinylcyclotetrasiloxane, 1,3,5,7-tetramethyl-1,3,5,7-tetrahexenylcyclotetrasiloxane, 1,3-divinyl-1,3-diphenyl-1,3-dimethyldisiloxane; 1,3-divinyl-1,1,3,3-tetramethyldisiloxane; and a combination of two or more thereof.

The concentration of the hydrosilylation reaction inhibitor (d) is typically greater than zero parts by mass and can be 0.02 parts by mass or more, even 0.8 parts by mass or more while at the same time are typically 1.0 parts by mass or less based on 100 mass parts of aliphatically unsaturated polyorganosiloxane (a).

### (e) Water

The water component can be process or unprocessed. Processed water includes water that has been purified by any one or more of the following: distilling, filtering, deionizing. Unprocessed water includes tap water and well water without further purification. The water is typically the primary component of the continuous, or carrier, phase of the coating composition emulsion. The amount of water in the coating composition emulsion is typically 30 weight-percent (wt %) or more, 50 wt % or more, even 60 wt % or more while at the same time typically 99 wt % or less, 95 wt % or less, or even 90 wt % or less based on the weight of the coating composition emulsion.

### (f) Buffer

The buffer can comprise a mono or polyprotic acid and its conjugate base and is useful for maintaining a desirable pH in the coating composition emulsion. Examples of suitable buffers include HCO₃⁻/CO₃²⁻ and H₂PO4⁻/HPO₄²⁻. The buffer can comprise NaCO₃ and NaHCO₃; and/or citric acid and a citrate salt such as potassium citrate or sodium citrate. The buffer can alternatively comprise sodium hydroxide and citric acid. The concentration of buffer is desirably greater than zero weight-parts, preferably 0.2 weight-parts or more, and can be 0.4 weight-parts or more while at the same time is typically 1.6 weight-parts or less, 1.5 weight-parts or less, or even 1.25 weight-parts of less based on 100 weight parts of aliphatically unsaturated polyorganosiloxane (a).

### (g) Silicone Polyether

The silicone polyether is as described above having the chemical structure (I). The concentration of the silicone polyether in the coating composition emulsion is desirably 0.05 weight-parts or more, 0.1 weight-part or more, 0.5 weight-part or more, one weight-part or more, 1.5 weight-part or more, 2 weight-part or more, even 2.5 weight-part or more while at the same time is typically 3 weight-parts or less, or 2.5 weight-parts or less, 2 weight-parts or less, 1.5 weight-parts or less, or even one weight-part or less based on 100 weight parts of aliphatically unsaturated polyorganosiloxane (a).

### (h) Polyvinyl Alcohol

Polyvinyl alcohol is known in the art and are disclosed, for example in U.S. Patent Application Publication 2007/0099007 at paragraphs [0172] and [0173]. Polyvinyl alcohol may be made by saponification of polyvinylacetate, and up to 65 mol % of polyvinylacetate may remain in the polyvinyl alcohol used herein. Alternatively, the polyvinyl alcohol can be 35 mol % to 99 mol % polyvinyl alcohol (with the balance being 65 mol % to 1 mol % polyvinylacetate). Alternatively, the polyvinyl alcohol can be hydrolyzed from 80% to 98%. The polyvinyl alcohol can have a minimum viscosity of 5 mPa*s at 4% aqueous solution at 20° C. and alternatively up to 200 mPa*s. Alternatively, the polyvinyl alcohol can have a viscosity of 15 mPa*s to 55 mPa*s.

Polyvinyl alcohol concentration in the coating composition emulsion is desirably zero weight-parts or more, and can be 1.5 weight-parts or more while at the same time is typically 10 weight-parts or less, and can be 5 weight-parts or less, or even 3 weight-parts or less based on 100 weight-parts of aliphatically unsaturated polyorganosiloxane (a). The combined concentration of silicone polyether (g) and polyvinyl alcohol (h) is desirably 3.0 weight-parts or more based on 100 weight-parts of aliphatically unsaturated polyorganosiloxane (a).

### (i) Biocide

The coating composition emulsion can optionally comprise a biocide. Suitable biocides include any one or combination of the following: fungicides, herbicides, pesticides and antimicrobial agents. Examples of suitable biocides include those described in U.S. Pat. No. 9,221,041. The concentration of biocide is zero weight-parts or more while at the same time is typically 1.0 weight-parts or less based on 100 weight-parts of aliphatically unsaturated polyorganosiloxane (a).

### (j) Co-Surfactant

The coating composition emulsion can optionally comprise a co-surfactant. The co-surfactant can be one co-surfactant or a combination of more than one co-surfactant. The co-surfactant can be nonionic, ionic, or a combination of nonionic and ionic. Examples of suitable nonionic co-surfactants include alkylphenols, fatty alcohols or fatty acids with alkylene oxide groups, such as ethylene oxide or propylene oxide groups. Suitable ionic co-surfactants include anionic surfactants such as sulfates, sulfonates, phosphates, and sulfosuccinates. Suitable surfactants for use herein as co-surfactants are exemplified by those described as surfactant (G) in U.S. Patent Application Publication 2007/0099007 at paragraphs [0167] to [0176]. One desirably co-surfactant is Poly(oxy-1,2-ethanediyl), which is commercially available under the name LUTENSOL™ XP100 from BASF (LUTENSOL is a trademark of BASF SE) and another is isotridecanol ethoxylated, which is commercially available under the name ROKAnol™ IT12 from PCC group (ROKAnol is a trademark of PCC Exol S.A.). The concentration of co-surfactant is zero weight-parts or more and at the same time is typically 3 weight-parts or less, 2 weight-parts or less, one weight-part or less, or even 0.5 weight-part or less, or 0.3 weight-part or less based on 100 weight-parts of aliphatically unsaturated polyorganosiloxane (a).

The coating composition can optionally include further components such and one or any combination of more than one selected from anti-foaming agents, non-functional polyorganosiloxanes, bactericidal agents (for example, sorbic acid), colorants (for example, a dye or pigment), filler (for example, silica), and wetting agents (for example glycols such as propylene glycol or ethylene glycol).

Examples of suitable anti-foaming agents include emulsions containing silica and polydimethylsiloxanes. Suitably commercially available anti-foaming agents include those available under the tradenames DOWSIL™ AFE-1520, DOWSIL™ 7989, SYL-OFF™ EM 7989 ANTIFOAM, XIAMETER™ AFE-0100, XIAMETER™ AFE-1510, XIAMETER™ AFE-1520, and XIAMETER™ AFE-1530. DOWSIL is a trademark of The Dow Chemical Company. XIAMETER and SYL-OFF are trademarks of Dow Silicones Corporation. The concentration of anti-foaming agents is zero weight-parts or more and at the same time 0.3 weight-parts or less based on 100 weight parts of aliphatically unsaturated polyorganosiloxane (a).

“Non-functional polyorganosiloxanes” refers to polymers having a backbone comprising alternating silicon atoms with oxygen atoms, with organic groups bonded to other valences of the silicon atoms, where such organic groups do not undergo hydrosilylation reaction with aliphatically unsaturated polyorganosiloxane (a) or polyorganohydrogensiloxane (b). The non-functional polyorganosiloxanes generally have the chemical formula (R¹₃SiO_{1/2})₂(R¹₂SiO_{2/2})_{c}, where R¹ is as described above, and subscript c has a value sufficient to provide the non-functional organopolysiloxane with a viscosity of 5 mPa*s to 60,000 mPa*s. Examples of non-functional organopolysiloxanes are α,ω-trialkylsiloxy-terminated polydialkylsiloxanes, such as α,ω-trimethylsiloxy-terminated polydimethylsiloxanes. The concentration of non-functional organopolysiloxanes in the coating composition emulsion is zero weight-parts or more and at the same time 15 weight-parts or less based on 100 weight parts of aliphatically unsaturated polyorganosiloxane (a).

Emulsions containing the silicone polyether of the present invention can be made by combining components together, preferably under shear or applying shear after combining them. To avoid premature hydrosilylation reaction in the coating composition emulsion, it is possible to withhold from the emulsion a reactant and/or catalyst until such time as it is desirable for the hydrosilylation reaction to occur and then mixing in the withheld component(s). Application of shear can occur using, for example, a rotor and stator mixer, homogenizer, microfluidizer, colloidal mill or sonolator (ultrasonic mixer). It is also possible to dilute an emulsion by blending in additional water if desired.

The coating composition emulsion is useful for coating substrates. Upon coating a substrate with the coating composition emulsion, the coated substrate can be heated to achieve curing of the coating composition emulsion coating the substrate. Typically, heat to a temperature in a range of 50 to 120° C. Heating also achieves drying of the coating. The cured coating is useful as a release coating on the substrate. Multiple coatings can be applied to a single substrate if so desired. Multiple coatings can be useful to increase coating thickness and/or coat multiple surface of a substrate. After curing and drying, the resulting coating typically has a thickness of greater than zero micrometers, desirably, 0.05 micrometers or more, 0.1 micrometers or more, 0.15 micrometers or more, even 0.2 micrometers or more while at the same time is typically 10 micrometers or less, 5 micrometers or less, one micrometer or less, and can be 0.9 micrometers or less, 0.8 micrometers or less, 0.7 micrometers or less, 0.6 micrometers or less, 0.5 micrometers or less, even 0.3 micrometer or less.

Coating substrates with coating composition emulsion can occur by essentially any coating method such as, for example, spin coating, brush coating, drop coating, spray coating, dip coating, roll coating, flow coating, slot coating, gravure coating, size press coating, film press coating, curtain coating, and any combination of these methods.

Suitable substrates include those made of plastic, paper, metal, ceramics, and any combination thereof. Substrates can be sheets or any shape.

### EXAMPLES

Table 1 identifies materials useful for making the following samples.

TABLE 1

| Component | Description | Source |
|---|---|---|
| Co- | Poly(oxy-1,2-ethanediy1) CAS | Commercially available under |
| Surfactant 1 | #160875-66-1 | the name LUTENSOL ™ |
| | | XP100 from BASF |
| Co- | Isotridecanol ethoxylated, CAS | Commercially available under |
| Surfactant 2 | #69011-36-5 | the name ROKAnol ™ IT12 |
| | | (Isotrideceth-12) from PCC |
| | | group |
| Linear | Allylethoxylate with 10 EO units on | Commercially available under |
| Olefinic | average | the name PLURIOL ™ A1OR |
| Polyether 1 | | from BASF |
| Linear | Vinyloxybutylpolyethylene oxide with | Commercially available under |
| Olefinic | 65 EO units on average | the name PLURIOL ™ |
| Polyether 2 | | A3090V from BASF |
| Linear | Vinyloxybutylpolyethylene oxide with | Commercially available under |
| olefinic | 135 EO units on average | the name PLURIOL ™ |
| polyether 3 | | A5890V from BASF |
| SPE 1 | Trisiloxypropylpolyethoxylate with 12 | Available under the name |
| | EO units on average, with an average | DOWSIL ™ 502W from The |
| | chemical composition: | Dow Chemical Company |
| | (CH₃)₃SiOCH₃ROSi(CH₃)₃ where R is | |
| | −(CH₃)₃O(CH₂CH₂O)₁₂H | |
| IPA | Isopropyl alcohol, 99.8% | Brenntag GmbH |
| NaOAc | Sodium acetate, > 99% | Sigma Aldrich |
| MDHM | 1,1,1,3,5,5,5-Heptamethyltrisiloxane, | TCI America |
| | greater than 98.0% pure | |
| Citric Acid | Citric Acid monohydrate, > 99.0% pure | Sigma Aldrich |
| Sodium | Sodium hydroxide solution, 40% w/w | Fisher Chemical |
| hydroxide | sodium hydroxide in water | |
| Vinyl | Linear vinyl end-capped with a single | Available under the name |
| Polymer | vinyl on each end of a polydimethyl | DMS-V22 from Gelest |
| | siloxane, with an average of 120 | |
| | dimethylsiloxane units (DP of 120) | |
| SIH | Linear trimethylsiloxy-terminated | Available under the name |
| Polymer | poly(dimethyl/methylhydrogen) | SYL-OFFTM 2-7672 |
| | siloxane with SiH content of 0.9 | Crosslinker from The Dow |
| | weight-percent SiH relative to polymer | Chemical Company |
| | SiH Polymer weight and a viscosity of | |
| | 31 square millimeters per second | |
| Non- | Trimethyl endblocked polydimethyl | Available under the name |
| Reactive | siloxane with an average viscosity of | DOWSILTM 200 Fluid, 12,500 |
| Polymer | 12,500 mm²/s | cSt |
| PVA | Polyvinyl alcohol solution, 10% w/w | Available under the name PVA |
| Surfactant | PVA in water | 40 TAD from BIM Kemi AB. |
| Pt Catalyst | 62% of Karstedt Pt catalyst (Platinum, | Karstedt's catalyst available |
| 1 | 1,3-diethenyl-1,1,3,3- | from Heraeus and 1,3- |
| | tetramethyldisiloxane complexes) | Divinyltetramethyldisiloxane |
| | diluted in 38% of | from Sigma-Aldrich |
| | Tetramethyldivinyldisiloxane | |
| Pt Catalyst | 1.26% of Karstedt Pt catalyst | Commercially available under |
| 2 | (Platinum, 1,3-diethenyl-1,1,3,3- | the name DOWSIL ™ 4000 |
| | tetramethyldisiloxane complexes) | Catalyst from The Dow |
| | diluted in Dimethyl Siloxane, | Chemical Company |
| | Dimethylvinylsiloxy-terminated, | |
| | Tetramethyldivinyldisiloxane and | |
| | Polydimethylsiloxane hydroxy- | |
| | terminated | |
| Antifoam | Proprietary emulsion of antifoam | Available under the name |
| | silicone compound | DOWSIL ™ 1530 Emulsion |
| | | from The Dow Chemical |
| | | Company |
| Biocide 1 | A 3:1 weight ratio blend of 5-chloro-2- | Available under the name |
| | methyl-2H-isothiazol-3-one and 2- | KATHONTM LXE from |
| | methyl-2H-isothiazol-3-one | Lanxess |
| Biocide 2 | Bronopol-based biocide | Available under the name |
| | | BIOBAN ™ BP-30 from |
| | | Lanxess |
| Inhibitor 1 | 1-ETHYNYL-1-CYCLOHEXANOL | Available under the name 1- |
| | | Ethynyl-1-cyclohexanol (ECH) |
| | | from BASF |
| Inhibitor 2 | 3,5-DIMETHYL-1-HEXYN-3-OL | Available under the name |
| | | SURFYNOL ™ 61 from Air |
| | | Products |

LUTENSOL is a trademark of BASF SE; ROKAnol is a trademark of PCC Exol S.A. Joint Stock Company; PLURIOL is a trademark of BASF SE Societas Europae; DOWSIL is a trademark of The Dow Chemical Company; SYL-OFF is a trademark of Dow Silicones Corporation; KATHON is a trademark of Nutrition & Biosciences USA2, LLC; BIOBAN is a trademark of The Dow Chemical Company; SURFYNOL is a trademark of Evonik Operations GMBH.

### NMR Procedure

Collect proton nuclear magnetic resonance (¹H NMR) spectra for samples using a BRUKER AVIII (400 MHz) NMR and using a silicon-free 10 mm tube and CDCl₃/Cr(AcAc)₃ solvent.

Collect silicon 29 nuclear magnetic resonance (²⁹Si NMR) spectra for samples using a BRUKER AVIII (600 MHz) NMR and using a silicon-free 10 mm tube and CDCl₃/Cr(AcAc)₃ solvent.

### Preparation of SPE 2—Example 1

Equip a 100 milliliter (mL) 3-neck flask with a magnetic stirrer, a condenser and a nitrogen inlet. Add to the 100 mL flask 47.84 g of Linear Olefinic Polyether 2, 3.75 g of MDHM and 0.19 g Citric Acid (to lower the pH from 10 to 7), 0.056 g of NaOAc, and 16.15 g IPA and mix the components together. Heat the resulting solution to a target of 80° C. When the temperature reaches 73.2° C. add 24 weight-parts per million (ppm) of catalyst composition based on combined weight of Linear Olefinic Polyether and MDHM. The catalyst composition comprises 5000 ppm Pt from Pt Catalyst 1 diluted in IPA. Maintain the solution at a temperature in a range of 76 to 78° C. for at least 9 hours while following the reaction by proton nuclear magnetic resonance spectroscopy (¹H NMR) and stop the heating when the reaction is complete as indicated by the ¹H NMR SiH peak at −4.7 ppm becoming flat. Strip off the IPA under vacuum (less than 0.08 MegaPascal pressure). Analysis by ¹H and ²⁹Si NMR shows the resulting product is 63.1 mole-percent (mol %) trisiloxyethyloxybutylpolyethoxylate with 65 ethylene oxide units on average per pendant group with no residual SiH functionality (Target SPE 2a; Example 1) and 36.9 mol % of a by-product obtained through condensation of MDHM with polyether terminal alcohol. Mol % is relative to all NMR peaks. Dilute the Target SPE 2a in water to obtain a 15 wt % solution of the SPE 2a in water to serve as SPE 2 for use in the Ex 3 formulation.

### Preparation of SPE 3—Example 2

Equip a 500 mL 3-neck flask with a magnetic stirrer, a condenser and a nitrogen inlet. Add to the 500 mL flask 296 g of Linear Olefinic Polyether 3, 11.06 g of MDHM and 1.16 g Citric Acid, 0.342 g of NaOAc, and 91.66 g IPA and mix the components together. Heat the resulting solution to a target of 90° C. Over the course of 24 hours, add 20.5 ppm of catalyst composition based on combined weight of Linear Olefinic Polyether and MDHM. The catalyst composition comprises 5000 ppm Pt Catalyst 1 in IPA. Maintain temperature until SiH disappears as evidenced by ¹H NMR. Strip off the IPA under vacuum (less than 0.09 MegaPascal pressure). Analysis by 1H and ²⁹Si NMR shows the resulting product is 63.1 mol % trisiloxyethyloxybutylpolyethoxylate with 135 ethylene oxide units on average per pendant group with no residual SiH functionality (Target SPE 3a; Example 2) and 36.9% of a by-product obtained through condensation of MDHM with polyether terminal alcohol. Mol % is relative to all NMR peaks. Dilute the Target SPE 3a in water to obtain a 15 wt % solution of the SPE 3a in water to serve as SPE 3 for use in the Ex 4 formulation.

### Preparation of Release Coating Compositions

Prepare release coating compositions by first preparing a Base Emulsion Composition and then combining Catalyst Emulsion with the Base Emulsion Composition and then diluting with an aqueous antifoam emulsion.

### Base Emulsion Composition Preparation

Table 2 provides the composition of the Base Emulsion Compositions with amounts in weight-percent (wt %) relative to the base emulsion composition weight.

First prepare an aqueous buffer solution by blending the water, citric acid and sodium hydroxide components together. Weigh out separately the Vinyl Polymer, SiH Polymer, Non-reactive Polymer components and mix them separately to form a polymer mix. The PVA Surfactant, Co-Surfactant 1, and the Linear Olefinic Polyether 1 or SPE components are mixed together separately to form a surfactant mix. Slowly add the surfactant mix to the polymer mix while emulsifying using a High Pressure Sonolator at 100 bars until a Dv0.9 particle size of (that is, 90% of the particles have sizes below this value) that is between 1.0 and 2.5 micrometers, preferably between 1.5 and 2.0 micrometers. Determine Dv09 particle size using laser diffraction spectroscopy with a Malvern Mastersizer 3000 instrument. To the emulsion add the buffer solution, Inhibitor 1, Inhibitor 2, Biocide 1 and Biocide 2 components while continuing to emulsify.

TABLE 2

| Component | Comp Ex A | Comp Ex B | Ex 3 | Ex 4 |
|---|---|---|---|---|
| Water | 48.3 | 47.1 | 39.56 | 39.56 |
| Citric Acid | 0.25 | 0.25 | 0.25 | 0.25 |
| Sodium Hydroxide | 0.22 | 0.22 | 0.22 | 0.22 |
| Vinyl Polymer | 36.44 | 35.67 | 35.23 | 35.23 |
| SiH Polymer | 1.56 | 1.53 | 1.51 | 1.51 |
| Non-Reactive Polymer | 1.95 | 1.96 | 1.93 | 1.93 |
| PVA Surfactant | 10 | 12.1 | 12.1 | 12.1 |
| Co- Surfactant 1 | — | 0.05 | 0.05 | 0.05 |
| Linear Olefinic | 1 | — | — | — |
| Polyether 1 | | | | |
| SPE 1 | — | 0.84 | — | — |
| SPE 2 | — | — | 8.87 | — |
| SPE 3 | — | — | — | 8.87 |
| Inhibitor 1 | 0.075 | 0.075 | 0.075 | 0.075 |
| Inhibitor 2 | 0.075 | 0.075 | 0.075 | 0.075 |
| Biocide 1 | 0.08 | 0.08 | 0.08 | 0.08 |
| Biocide 2 | 0.05 | 0.05 | 0.05 | 0.05 |

Characterization of Base Emulsion Compositions

| | | | | |
|---|---|---|---|---|
| Wt % Siloxane content | 40 | 40 | 40 | 40 |
| Molar ratio of | 1.85 | 1.85 | 1.85 | 1.85 |
| silicon hydride | | | | |
| groups to vinyl groups | | | | |

To the resulting base emulsion composition add Catalyst Emulsion at a concentration ratio of 95:5 where the concentration ratio is based on relative weight of Base Emulsion Composition to Catalyst Emulsion. Dilute the resulting mixture with a solution of water containing the Antifoam. The resulting Bath composition contains 62.45 wt % water, 35.63 wt % Base Emulsion, 1.88 wt % Catalyst Emulsion and 0.05 wt % Antifoam. The Bath contains 15 wt % siloxane content.

### Catalyst Emulsion Preparation

Table 3 provides the composition of the Catalyst Emulsion Compositions with amounts in weight-percent (wt %) relative to the Catalyst Emulsion weight.

First prepare an aqueous buffer solution by blending the water, citric acid and sodium hydroxide components together. Weigh out separately the Vinyl Polymer, Pt Catalyst 2 and mix them separately to form a polymer mix. The PVA Surfactant, Co-Surfactant 2 components are mixed together separately to form a surfactant mix. Slowly add the surfactant mix to the polymer mix while emulsifying using a High Pressure Sonolator at 100 bars until a Dv0.9 particle size of (that is, 90% of the particles have sizes below this value) that is between 1.0 and 2.5 micrometers, preferably between 1.5 and 2.0 micrometers. Determine Dv09 particle size using laser diffraction spectroscopy with a Malvern Mastersizer 3000 instrument. To the emulsion add the buffer solution, Biocide 1 and Biocide 2 components while continuing to emulsify.

TABLE 3

| Component | Amount |
|---|---|
| Water | 45.32 |
| Citric Acid | 0.2 |
| Sodium Hydroxide | 0.18 |
| Vinyl Polymer | 33.3 |
| Pt Catalyst 2 | 6.7 |
| PVA Surfactant | 14 |
| Co- Surfactant 2 | 0.17 |
| Biocide 1 | 0.08 |
| Biocide 2 | 0.05 |
| Wt % Siloxane content | 40 |
| Molar ratio of silicon hydride groups to vinyl groups | 1.85 |

### Preparation of Coated Paper Substrates

Prepare coated baking paper samples with the Release Coating Composition Emulsions to preparing test Baking Paper samples. Apply each of the four Release Coating Composition Emulsions to a separate paper substrates (bare cellulosic paper, 40 grams per square meter) to form four test baking paper samples. Apply release Coating Composition Emulsions to the paper substrate using a bench top rotary printing and coating machine (The Rotary Koater from RK Print-Coat Instrument Ltd.). Use a plain roll for these samples and set the speed at 7 meters per minute in order to achieve a target silicone coat weight of 0.2 to 0.5 grams per square meter on the paper substrate. Once coated, cure and dried the coated paper substrate in-line with an oven at 110 to 180° C. Cut the resulting coated paper substrates into sheets A4 in size to characterize for coating weight, water resistance using the Cobb Water Resistance Test, and release capability using the Bakery Release Test.
Comp Ex C is a Coated Paper Substrate coated using Comparative Example A.
Comp Ex D is a Coated Paper Substrate coated using Comparative Example B.
Ex 5 is a Coated Paper Substrate coated using Example 3.
Ex 6 is a Coated Paper Substrate coated using Example 4.

### Sample Characterization

### Coating Weight

Determine the coating weight of the Release Coating Composition Emulsions on the paper substrate using X-Ray Fluorescence with an Oxfort lab x3500 CRF Analyzer after silicon elemental calibration with sample standards. Signal strength is related to the sample thickness of the layer under analysis. Perform 3 measurements on each sample and take an average of those three measurements as for the average coating weight in grams per square meter (g/m²).

### Bakery Release Test

The Bakery Release Test measures the quantity of food left on a coated substrate after oven baking the food on the coated substrate. Fold coated substrates to form rectangular baking molds (typically 15 centimeters (cm) by 18 cm by 2 cm deep. Weight the rectangular baking molds.

Prepare cake batter containing 4 eggs, 80 grams (g) of sugar, 80 g of potato and 85 g of wheat flour, and 5.5 g of baking powder in a universal kitchen mixer. Place cake batter in the rectangular baking molds. Bake the cake batter in the rectangular baking molds for 8 minutes at 200° C. Allow the resulting cakes to cool in the rectangular baking molds and then remove the cakes from the rectangular baking molds. Peel the coated substrate from the cake and weigh them again. Subtract the resulting weight from the original coated substrate weight (original weight of the rectangular baking mold) to determine the mass of baking residue. Divide the mass of baking residue by the area of the coated substrate to determine baking residue in terms of grams residue per square meter of coated substrate (g/m² baking residue). The target is to achieve 12 g/m² or less baking residue.

### Cobb Water Resistance Test: Water Uptake

Characterize the water resistance of coatings of the Coated Paper Substrates using a Cobb test as set forth in the TAPPI 441 OM-04 test method. Expose samples of Coated Paper Substrates to water and measure the mass of water update after 60 seconds. Divide the mass by the area of Coated paper Substrate exposed to water to get a Water Uptake value in terms of g/m². The target is to obtain a Water Uptake value of less than 20 g/m², preferably less than 15 g/m².

### Characterization Results

Table 4 provides the Characterization Results for Comparative Examples C and D and Examples 5 and 6.

TABLE 4

| | Characterization Results for Each Sample | | | |
|---|---|---|---|---|
| Characterization Test | Comp Ex C | Comp Ex D | Ex 5 | Ex 6 |
| Coat Weight (g/m²) | 0.21 | 0.40 | 0.42 | 0.31 |
| Water Uptake (g/m²) | 13.3 | 14.7 | 12.9 | 13.4 |
| Baking Residue (g/m²) | 62.7 | 14.9 | 8 | 11 |

The characterization results in Table 3 illustrate that Ex 5 and Ex 6 achieve the target values for both Water Uptake and Baking Residue. The two Comp Exs fail to achieve the target Baking Residue results.

1. A composition comprising a silicone polyether having the following chemical structure (I): 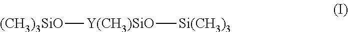
wherein Y is —(CH₂)₂O(CH₂)₄O(CH₂CH₂O)ₙH and subscript n has an average value in a range of one to 500.

2. The composition of claim 1, wherein subscript n has a value in a range of 50 to 150.

3. The composition of claim 1, wherein the composition is an aqueous emulsion containing the silicone polyether.

4. The composition of claim 3, wherein the composition is coating composition emulsion comprising:
(a) an aliphatically unsaturated polyorganosiloxane of unit formula (A-I): 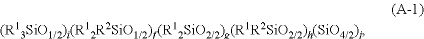
wherein each R¹ is an independently selected alkyl group, each R² is an independently selected alkenyl group, subscripts i, f, g, h, and j represent average numbers of each siloxane unit per molecule, and subscripts i, f, g, h, and j have values such that i is in a range of zero to 4, f is in a range of zero to 4; g is in a range of zero to 1400; h is in a range of zero to 200; and j is zero or one; with the provisos that if a quantity (i+f) is in a range of 2 to 4 then a quantity (f+h) is at least 2, and a quantity (i+f+g+h) is in a range of 15 to 1400;
(b) a polyorganohydrogensiloxane in an amount sufficient to provide a molar ratio of silicon bonded hydrogen atoms in (b) the polyorganohydrogensiloxane to silicon bonded alkenyl groups in (a) the aliphatically unsaturated polyorganosiloxane of 1.2:1 to 3.0:1;
(c) a hydrosilylation reaction catalyst in an amount sufficient to provide 10 ppm to 1000 ppm of a platinum group metal based on combined weights of (a) the aliphatically unsaturated polyorganosiloxane and (b) the polyorganohydrogensiloxane;
(d) a hydrosilylation reaction inhibitor at a concentration of greater than zero weight part to 1.0 weight parts per 100 weight parts of (a) the aliphatically unsaturated polyorganosiloxane;
(e) water;
(f) buffer at a concentration of 0.2 weight part to 1.6 weight parts, per 100 weight parts of (a) the aliphatically unsaturated polyorganosiloxane;
(g) the silicone polyether at a concentration of 0.05 weight part to 3 weight parts, per 100 weight parts of (a) the aliphatically unsaturated polyorganosiloxane;
(h) optionally, polyvinyl alcohol at a concentration of 0 to 10 weight parts, per 100 weight parts of (a) the aliphatically unsaturated polyorganosiloxane;
(i) optionally, a biocide;
(j) optionally, a co-surfactant; and
(k) optionally, an anti-foaming agent.

5. The composition of claim 4, wherein subscripts i=j=h=0, subscript f=2, and the aliphatically unsaturated polyorganosiloxane is a bis-alkenyl-terminated polydiorganosiloxane with unit formula (R¹₂R²SiO_{1/2})₂(R¹₂SiO_{2/2})_{g}, where each R¹ is methyl, each R² is vinyl, and subscript g is 15 to 1200.

6. The composition of claim 4, wherein the polyorganohydrogensiloxane has unit formula (R¹₃SiO_{1/2})₂(R¹HSiO_{2/2})_{z}, where R¹ is methyl and subscript z is in a range of 3 to 250.

7. The composition of claim 4, wherein the hydrosilylation reaction inhibitor comprises an acetylenic alcohol.

8. The composition of claim 4, wherein the buffer comprises citric acid and sodium hydroxide.

9. The composition of claim 4, the composition further comprises a substrate and the coating composition emulsion coats at least one surface of the substrate.

10. The composition of claim 9, wherein the substrate is paper sheet.
